(19) United States
(12) Patent Application Publication
(10) Pub. No.: US 2005/0099165 A1
(43) Pub. Date: May 12, 2005

(54) Power controller

(76) Inventor: Katsuhiko Tani, Takefu-city (JP)

Correspondence Address: FLYNN THIEL BOUTELL & TANIS, P.C., 2026 RAMBLING ROAD, KALAMAZOO, MI, 49008-1699, US

(21) Appl. No.: 10/975,856

(22) Filed: Oct. 28, 2004

(30) Foreign Application Priority Data
Nov. 7, 2003 (JP) 2003-379182

(51) Int. Cl. G05F 1/577

(52) U.S. Cl. 323/267

(57) ABSTRACT

It is an object of the invention to provide a power controller in the conventional circuit configuration capable of realizing significant reduction of a voltage in a standby state. The power controller comprises a power transformer which is connected to a commercial power via a switching power control circuit, and has first to third output windings at a secondary winding, wherein a reference voltage to be inputted to an error amplifier is an output voltage outputted from the first output winding in a normal mode while it is switched to an output voltage outputted from the third output winding in a standby mode. A significant reduction of a voltage can be realized in a standby mode by switching the reference voltage to the output voltage outputted from the third output winding which is higher than the output voltage outputted from the first output winding.

### FIELD OF THE INVENTION

The invention relates to a power controller for use in electronic equipment such as a television receiver, and the like for enabling reduction of power consumption in a standby mode.

### BACKGROUND OF THE INVENTION

There is electronic equipment such as a television receiver and so forth to which a power is supplied even in a state where electronic equipment is not used (hereinafter referred to as non-use state), thereby setting it at a standby mode. The electronic equipment can be set at a use-state in a short time when it is rendered in such a standby state, thereby enhancing the convenience thereof. On the one hand, there is a problem that power is consumed even in a non-use state, thereby consuming wasteful energy.

To cope with such a problem, JP 11-215819A discloses improvement of efficiency by intermittently oscillating a switching power controller in a standby mode. This is caused by the fact that since an oscillation frequency of the switching power controller has correlation with a conversion efficiency of a transformer, in order to prevent the phenomenon wherein the oscillation frequency becomes anomalously high when a secondary winding of the transformer is rendered in a state of lower power consumption in a standby mode, the oscillation is temporally stopped to intentionally generate a high load state to keep the oscillation frequency having excellent conversion frequency. Further, JP 2000-209524A discloses the provision of an error amplifier for effecting a stable voltage control based on an output voltage of a switching power controller and output voltage conversion means for converting the output voltage of the switching power control circuit to be supplied to the error amplifier.

FIG. 2 shows an example of an electric switching controller as disclosed in the foregoing prior art references. A switching power control circuit 2 connected to a commercial power 1 is connected to a primary winding 3a of a power transformer 3. Secondary winding 3b and 3c of the power transformer 3 output different output voltages V1 and V2.

The secondary winding 3b is connected to a rectifying diode D1, an electrolytic capacitor for smoothing (hereinafter referred to as smoothing electrolytic capacitor) C1 and also connected to a display unit and the like, not shown, to supply the voltage V1. A rectifying diode D2, a smoothing electrolytic capacitor C2 and a constant voltage circuit 4 are connected to the secondary winding 3c. The constant voltage circuit 4 supplies the output voltage V2 to a control circuit 5.

A light emitting element D3 is connected to a voltage line through which the output voltage V2 is supplied from the secondary winding 3c via a current restriction resistor R1, and the light emitting element D3 constitutes a photocoupler together with a photo acceptance element Tr1 provided in the switching power control circuit 2. An error amplifier D4 is serially connected to the light emitting element D3. The error amplifier D4 employs a shunt regulator and operates to be stabilized at a predetermined reference voltage. Voltage divider resistors R2 and R3 are connected to the voltage line of the voltage V2 in the manner that the voltage divided by these resistors is inputted to the error amplifier D4. A resistor R4 for voltage conversion (hereinafter referred to voltage conversion resistor) and a transistor Tr2 are connected to the voltage divider resistors R2 and R3, and a base of the transistor Tr2 is connected to the control circuit 5.

When the power controller is in a normal operation state, an output signal is not transmitted from the control circuit 5 to the transistor Tr2 so that the transistor Tr2 is rendered OFF. Accordingly, the voltage divided by the voltage divider resistors R2 and R3 is inputted to the error amplifier D4 as a reference voltage. The light emitting element D3 emits light if there occur anomalies in the voltage line of the voltage V2, and the emitted light of the light emitting element D3 is detected by the photo acceptance element Tr1 so as to generate a feedback current in the switching power control circuit 2, so that a feedback control is effected relative to the primary winding, thereby adjusting voltage anomalies of the output voltage at the secondary winding.

In the case where the power controller is rendered in a standby state, an output signal representing a standby mode is transmitted from the control circuit 5 to the transistor Tr2 to turn on the transistor Tr2. When the transistor Tr2 is turned on, the voltage divided by the voltage divider resistor R2 and the voltage conversion resistor R4 is inputted to the error amplifier D4. Provided that the voltage conversion resistor R4 is set at a resistor value which is smaller than the voltage divider resistor R3, the reference voltage to be inputted to the error amplifier D4 can be reduced. When the reference voltage is reduced, a feedback control is effected relative to the primary winding via the light emitting element D3 and photo acceptance element Tr1 so that the entire output voltage at the secondary winding is reduced, thereby reducing power consumption in a standby state.

For example, in the case where the voltage V1 is set at 15V, the voltage V2 is set at 5V, and the voltage divided by the voltage divider resistors R2 and R3 is inputted to the error amplifier D4 in a normal operation state of the power controller, it is possible to reduce an input voltage up to 2.5V which is a reference voltage designed for the shunt regulator of the error amplifier D4 in the standby state, however, the limit of the reduction is generally about 3V. Accordingly, if the voltage V2 is reduced to 3V, the voltage V1 is reduced to 9V in view of the turn ratio, however the reduction of voltage exceeding 9V can not be realized in the standby state.

### SUMMARY OF THE INVENTION

Accordingly, it is an object of the invention to provide a power controller capable of realizing significant reduction of voltage in a standby state with a conventional circuit configuration.

To achieve this object, a first aspect of the invention is to provide a power controller comprising a power circuit including a power transformer for outputting voltages each having a different level from multiple output windings of a secondary winding of the power transformer in response to a turn ratio, a stabilized circuit of an output voltage (hereinafter referred to as output voltage stabilized circuit) for effecting a feedback control relative to the power circuit based on one of the output voltages, a control circuit for outputting a control signal corresponding to a normal mode or a standby mode, and a switching circuit for switching a level of the output voltage serving as a reference voltage of the output voltage stabilized circuit to a level of the output voltage that is outputted from another output winding of the secondary winding and set at a level higher than a level of the output voltage outputted from one output winding of the secondary winding in response to the control signal corresponding to the standby mode. Further, the switching circuit switches the level of the output voltage to be supplied to the control circuit to a level of the voltage that is outputted from another output winding of the secondary winding and set at the level higher than the level of the output voltage outputted from one output winding of the secondary winding in response to the control signal corresponding to the standby mode.

With the configuration set forth above, the output voltage serving as the reference of the output voltage stabilized circuit in a standby mode is switched to a different output voltage having a level which is higher than a level in a normal mode so that if the output voltage stabilized circuit effects feedback control relative to the power circuit based on the high-level output voltage, it is possible to realize a significant reduction of the output voltage. That is, in the case where the high-level output voltage is reduced to a critical value of the output voltage of the output voltage stabilized circuit, there occurs the reduction of the voltage in the power circuit in response to the turn ratio of the secondary winding even for the output voltage other than the high-level output voltage, so that the entire output voltage having multiple different levels can be significantly reduced. Accordingly, there occurs the reduction of the loss of the voltage by the amount corresponding to the significant reduction of the entire output voltage at the secondary windings.

Although the output voltage to be supplied to the control circuit is affected by the reduction of voltage, if it is switched so as to supply a high-level output voltage, the output voltage having substantially the same level in the normal mode can be maintained. That is, if the high-level output voltage becomes substantially the same level as the output voltage in the normal mode owing to the reduction of voltage in the standby mode, when the output voltage is switched to that of the output winding which is set at the output voltage, thereby keeping an operable condition in the same manner as the normal state.

### BRIEF DESCRIPTION OF THE DRAWINGS

FIG. 1 is a circuit configuration according to an embodiment of the invention; and

FIG. 2 is a circuit configuration of a prior art.

### BEST MODE FOR CARRYING OUT THE INVENTION

An embodiment of the invention is now described in detail. Since the embodiment is a preferable concrete example for carrying out the invention, and various technical limitations are made, but the invention is not limited to the embodiment unless it is clearly described to limit the invention.

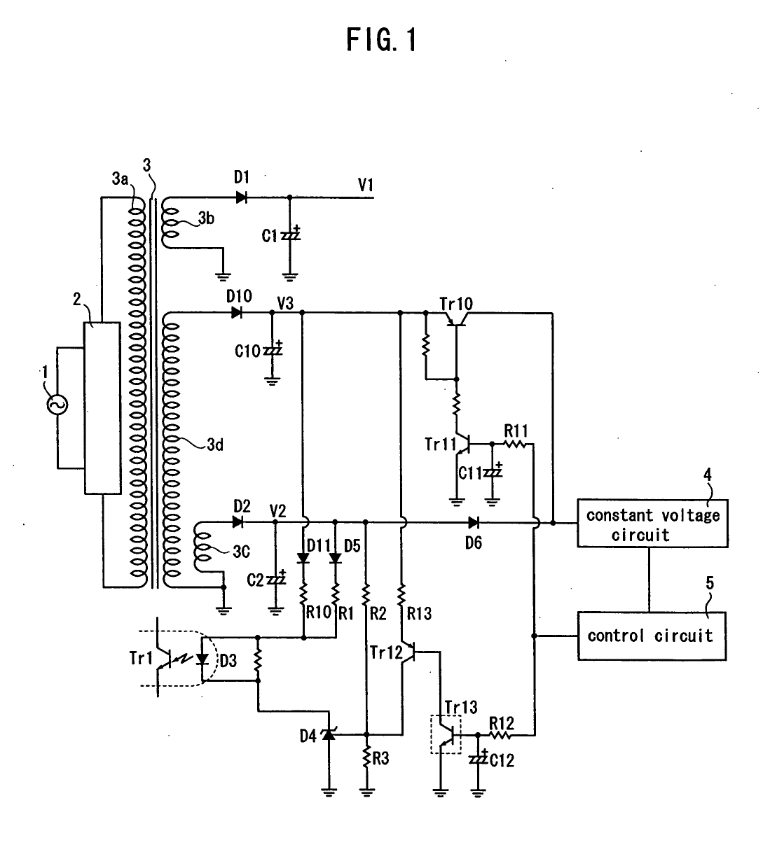

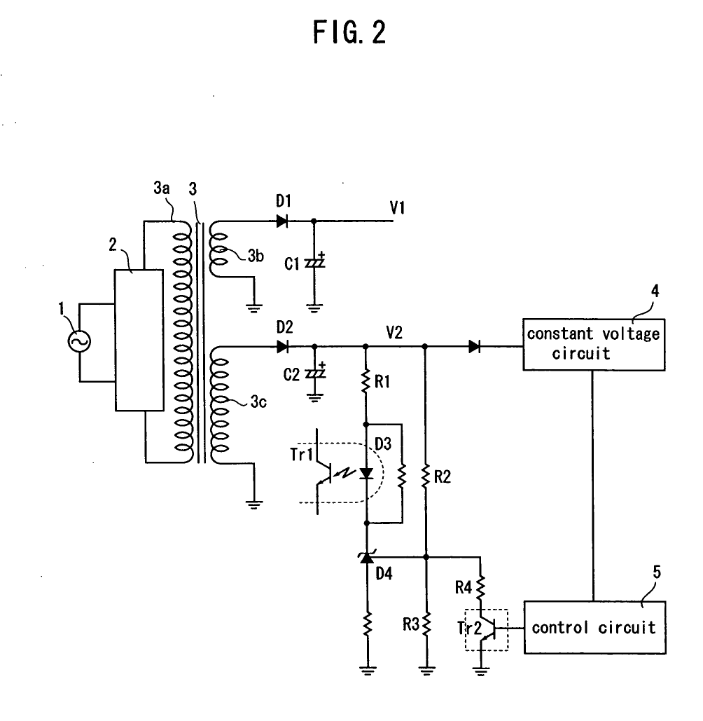

FIG. 1 is a circuit configuration according to an embodiment of the invention. In FIG. 1, constituents which are depicted by the same reference numerals as those in FIG. 2 show the same circuits and the like as explained in FIG. 2.

A winding 3d is provided in a power transformer 3 in addition to windings 3b and 3c serving as output windings of a secondary winding as explained in FIG. 2. The winding 3d is set to be larger in turn ratio than the windings 3b and 3c. A rectifying diode D10 and an electrolytic capacitor C10 for smoothing are connected to the winding 3d for supplying an output voltage V3 to the rectifying diode D10 and the electrolytic capacitor C10 for smoothing.

An anode side of a diode D11 for preventing a reverse current is connected to a voltage line of the output voltage V3, and a cathode side terminal of the diode D11 for preventing a reverse current is connected to one terminal of a resistor R10 for current limitation while the other terminal of the resistor R10 is connected to a light emitting element D3 together with a resistor R1. Further, one terminal of a voltage conversion resistor R13 is connected to the voltage line of the output voltage V3 while the other terminal of the voltage conversion resistor R13 is connected to an emitter terminal of a transistor Tr12. A collector terminal of the transistor Tr12 is connected between the voltage divider resistors R2 and R3, and also connected to an error amplifier D4.

An emitter terminal of a transistor Tr10 is connected to the voltage line of the output voltage V3 while a collector terminal of the transistor Tr10 is connected to a voltage line of an output voltage V2 and also connected to a constant voltage circuit 4. A collector terminal of a transistor Tr11 is connected to a base terminal of the transistor Tr10 while an emitter terminal of the transistor Tr11 is grounded. A collector terminal of the transistor Tr13 is connected to a base terminal of the transistor Tr12 while an emitter terminal of the transistor Tr13 is grounded. A base terminal of the transistor Tr11 is connected to a control circuit 5 via time constant circuits R11 and C11 while a base terminal of the transistor Tr13 is connected to the control circuit 5 via time constant circuits R12 and C12.

With the circuit configuration set forth above, the switching power control circuit 2 and the power transformer 3 correspond to a power circuit while the error amplifier D4 and the light emitting element D3 correspond to a output voltage stabilized circuit. Further, the transistors Tr10, Tr11, Tr12 and Tr13 correspond to a switching circuit.

A diode D5 for preventing a reverse current is connected between the voltage line of the voltage V2 and the resistor R1 while a diode D6 for preventing a reverse current is connected between the voltage line of the voltage V2 and the constant voltage circuit 4.

In a normal operation state, since an output signal from the control circuit 5 is not transmitted to the transistors Tr11 and Tr13, the transistors Tr11 and Tr13 are rendered in OFF state, so that the transistors Tr10 and Tr12 are also rendered in OFF state, and hence the output voltage V3 is not supplied to the constant voltage circuit 4 and the error amplifier D4. Accordingly, the output voltage V2 is supplied to the constant voltage circuit 4 while the voltage obtained by dividing the voltage V2 by the voltage divider resistors R2 and R3 is inputted to the error amplifier D4. Accordingly, a feedback current is generated at the switching power control circuit 2 via the light emitting element D3 based on the output voltage V2.

In a standby state, an output signal for instructing a standby mode is transmitted from the control circuit 5 to the transistors Tr11 and Tr13. At this time, the timing adjustment of the output signal to the transistors Tr11 and Tr13 is effected by the time constant circuits R11 and C11 and the time constant circuits R12 and C12 so that the transistors Tr11 and Tr13 are rendered in ON state in response to the output signal from the control circuit 5. The timing adjustment of the time constant circuits R11 and C11 and the time constant circuits R12 and C12 is effected in the manner that the output voltage V3 is not connected to the constant voltage circuit 4 in a high-level voltage. Accordingly, it is sufficient to adjust the timing of both the time constant circuits in the manner that the transistor Tr13 is turned on earlier than the transistor Tr11.

When the transistor Tr13 is rendered in ON state, the transistor Tr12 is also rendered in ON state so that the voltage obtained by dividing the output voltage V3 by the resistor R13 and resistor R3 is to be inputted to the error amplifier D4. Further, since the voltage line of the output voltage V3 is connected to the light emitting element D3 via the diode D11 and the resistor R10, the error amplifier D4 effects the feedback control based on the output voltage V3.

On the one hand, since the transistor Tr11 is rendered in ON state, the transistor Tr12 is rendered in ON state. Since the winding 3d of the power transformer 3 is larger in turn ratio than the other windings 3b and 3c, the output voltage V3 is set at a level higher than the output voltage V2, so that the output voltage V3 is supplied to the constant voltage circuit 4 when the transistor Tr12 is brought into conduction.

In the case where the error amplifier D4 effects the feedback control based on the output voltage V3, an output voltage can be significantly reduced. For example, if the turn ratio of the windings 3b, 3c, 3d is set at 3:1:10, the output voltages have values corresponding to the turn ratio in a normal operation state, i.e., V1=15V, V2=5V, V3=50V. If the output voltage V3 in a standby mode is reduced to the same level as the output voltage V2 in a normal operation state, the voltages have values, i.e., V1=1.5V, V2=0.5V, V3=5V. In order to reduce the output voltage V3 to 5V, it is sufficient to set the voltages to be inputted to the error amplifier D4 at appropriate values by adjusting the ratio of resistor values between the resistor R13 and the resistor R3. Accordingly, the voltage can be significantly reduced while the level of voltage to be supplied to the constant voltage circuit 4 is kept in the standby state and also the power consumption in the standby state can be also significantly reduced. Still further, since the output voltage at the secondary winding of the power transformer is rendered in a significant reduction state, the loss of voltage at the secondary winding of the power transformer can be significantly reduced.

Although the embodiment shows that the output signal is transmitted from the control circuit 5 in the standby mode, the circuit configuration may be changed in the manner that the output signal is transmitted in the normal mode while it is stopped in transmission in the standby mode.

The disclosure of Japanese Patent Application No. 2003-379182 including specification, claims, and drawings, is incorporated herein by reference.

1. A power controller comprising:
a power circuit including a power transformer for outputting voltages each having a different level from multiple output windings of a secondary winding of the power transformer in response to a turn ratio;
an output voltage stabilized circuit for effecting a feedback control relative to the power circuit based on one of the output voltages;
a control circuit for outputting a control signal corresponding to a normal mode or a standby mode; and
a switching circuit for switching a level of the output voltage serving as a reference voltage of the output voltage stabilized circuit to a level of the output voltage that is outputted from another output winding of the secondary winding and set at a level higher than a level of the output voltage outputted from one output winding of the secondary winding in response to the control signal corresponding to the standby mode.

2. A power controller according to claim 1, wherein the switching circuit switches the level of the output voltage to be supplied to the control circuit to a level of the voltage that is outputted from another output winding of the secondary winding and set at the level higher than the level of the output voltage outputted from one output winding of the secondary winding in response to the control signal corresponding to the standby mode.
